(19) United States
(12) Patent Application Publication
(10) Pub. No.: US 2008/0055430 A1
(43) Pub. Date: Mar. 6, 2008

(54) Method, apparatus, and system providing polynomial based correction of pixel array output

(76) Inventor: Graham Kirsch, Hants (GB)

Correspondence Address: DICKSTEIN SHAPIRO LLP, 1825 EYE STREET, NW, WASHINGTON, DC, 20006, US

(21) Appl. No.: 11/512,303

(22) Filed: Aug. 30, 2006

(30) Foreign Application Priority Data
Aug. 29, 2006 (GB) 0617001.3

(51) Int. Cl. H04N 5/217

(52) U.S. Cl. 348/241

(57) ABSTRACT

Methods, apparatuses, and systems which correct values generated by pixels in a pixel array. From a row value and from stored polynomial coefficients, a polynomial correction function associated with a pixel location is generated. From the correction function and a column value associated with the pixel, a correction factor is calculated for the pixel. The stored polynomial coefficients are generated before correction using a calibration process.

### FIELD OF THE INVENTION

Embodiments of the invention relate generally to image processing and more particularly to approaches for adjusting acquired values from an array of pixels.

### BACKGROUND OF THE INVENTION

Digital cameras include various components. One of the components is a pixel array. FIG. 1 is a diagram of a pixel array 2. Array 2 is made up of many pixels 2a arranged in rows and columns. Each pixel senses light and forms an electrical signal corresponding to the amount of light sensed. To capture a digital representation of light entering the camera based on an image, circuitry converts the electrical signals from each pixel to digital values and stores them. Each of these stored digital values corresponds to a component of the viewed image entering the camera as light.

In an ideal digital camera, each pixel in the array behaves identically regardless of its position in the array. As a result, all pixels should have the same output value for a given light stimulus. For example, consider an image of an evenly illuminated featureless gray calibration field, such as the field shown in FIG. 2. Because the light intensities of each component of this image is equal, if an ideal camera photographed this image, each pixel of a pixel array would generate the same output value.

Actual digital cameras do not behave in this ideal manner. When a digital camera photographs the image of FIG. 2, the values read from the pixel array are not necessarily equal. For example, instead of generating pixel values that correspond to the field of FIG. 2, the array in a typical digital camera might generate pixel values that correspond to the field of FIG. 3. In the digital image illustrated in FIG. 3, pixel signals from portions 4b near the outside of the array are darker than pixel signals from the center portion 4a of the image, even though their outputs should be uniform.

A wide variety of factors cause this pixel output attenuation problem. These factors relate to various components of the camera including the different lenses and/or filters which may be used, as well as pixel array differences caused by fabrication, etc. There is a need and a desire to mitigate this problem.

### BRIEF DESCRIPTION OF THE DRAWINGS

FIG. 1 is a diagram of a pixel array.

FIG. 2 illustrates an evenly illuminated featureless gray calibration field.

FIG. 3 illustrates an image that a digital camera might capture of the image of FIG. 2.

FIGS. 4 and 5 illustrate a method of correcting pixel values.

FIG. 6 illustrates a method of correcting pixel values in accordance with an embodiment described herein.

FIG. 6a illustrates a correction device in accordance with an embodiment described herein.

FIG. 7 illustrates a method of determining coefficients for use in accordance with the embodiment of FIG. 6.

FIG. 7a illustrates a calibration device in accordance with an embodiment described herein.

FIG. 8 illustrates a pixel array having a Bayer color filter.

FIG. 9 illustrates an image processor in accordance with an embodiment described herein.

FIG. 10 illustrates an imaging device in accordance with an embodiment described herein.

FIG. 11 illustrates a processing system, e.g., a camera system, in accordance with an embodiment described herein.

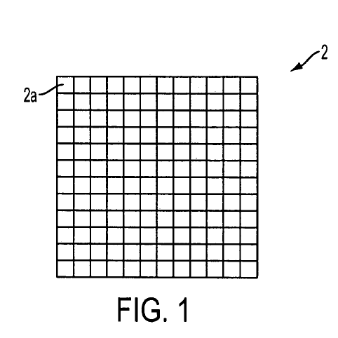

### DETAILED DESCRIPTION

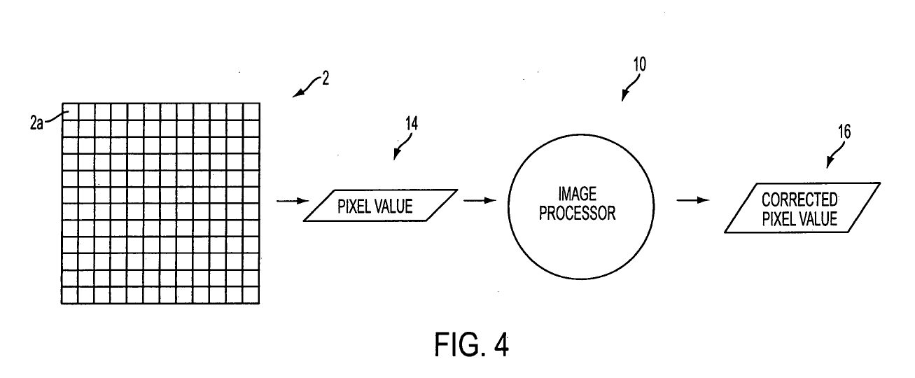

FIG. 4 is a diagram showing the basic components of a pixel correction process flow. FIG. 4 shows a portion of an image processor 10 capable of acquiring values generated by pixels 2a in a pixel array 2 and performing operations on the acquired values to provide corrected pixel values. The operations performed by image processor 10 in accordance with an embodiment disclosed herein use polynomial functions where the polynomials are generated from stored coefficient values. As but one non-limiting example, the embodiment may be used for positional gain adjustment of pixel values to adjust for different lens shading characteristics.

One could use any type of image processor 10 to implement the various embodiments, including processors utilizing hardware including circuitry, software storable in a computer readable medium and executable by a microprocessor, or a combination of both. The embodiment may be implemented as part of an image capturing system, for example, a camera, or as a separate stand-alone image processing system which processes previously captured and stored images. Additionally, one could apply the embodiment to pixel arrays using any type of technology, such as arrays using charge coupled devices (CCD) or using complementary metal oxide semiconductor (CMOS) devices, or other types of pixel arrays.

As illustrated by FIG. 4, image processor 10 acquires at least one pixel value 14 from pixel array 2 and then determines and outputs at least one corrected pixel value 16. Image processor 10 determines a corrected pixel value 16 based, for example, on pixel 2a's position in the array 2. It is known that the amount of light captured by a pixel near the center of the array is greater than the amount of light captured by a pixel located near the edges of the array due to various factors, such as lens shading.

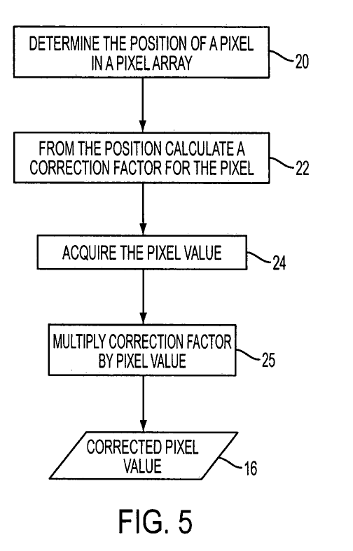

The overall process performed by image processor 10 is illustrated in FIG. 5. Thus, in step 20, the position of an incoming pixel value in the array is determined, which corresponds to a row value and a column value. Based on the row and column values, image processor 10 determines a correction factor for the pixel value (step 22). Once the image processor 10 determines the correction factor, it calculates a corrected pixel value 16 by multiplying an acquired pixel value (step 24) by the calculated correction factor (step 25) as follows:

SV_{corrected}=SV_{acquired}×Correction_factor.

The correction factor is determined using polynomial functions. The following polynomial of order n, referred to herein as the correction function, approximates the value of the correction factor:

Correction_factor=Qₙcolⁿ+Qₙ₋₁colⁿ⁻¹+ . . . +Q₁col¹+Q₀. (1)

Qₙ through Q₀ are the coefficients of the correction function whose determination is described below. A different set of these Q coefficients is determined for each row of the array. The notation “col” refers to a variable which is the column value of the pixel determined with respect to an origin (0,0) located near the center of the array and scaled to a value between −1 and +1 depending on the pixel location in the array relative to the center (0,0). The letter “n” represents the order of the polynomial, so for embodiments using an order 5 correction factor, the correction factor would be represented as follows:

Correction_factor=Q₅col⁵+Q₄col⁴+Q₃col³+Q₂col²+Q₁col¹+Q₀. (1a)

In equation (1), Q coefficients, Qₙ through Q₀, are determined using polynomial functions. The following polynomials of order m approximate coefficients Qₙ through Q₀:

Qₙ=P_{(n,m)}row^{m}+P_{(n,m-1)}row^{m-1}+ . . . +P_{(n,1)}row¹+P_{(n,0)} (2)

Qₙ₋₁=P_{(n-1,m)}row^{m}+P_{(n-1,m-1)}row^{m-1}+ . . . +P_{(n-1,1)}row¹+P_{(n-1,0)} (3)

. . .

Q₁=P_{(1,m)}row^{m}+P_{(1,m-1)}row^{m-1}+ . . . +P_{(1,1)}row¹+P_{(1,0)} (4)

Q₀=P_{(0,m)}row^{m}+P_{(0,m-1)}row^{m-1}+ . . . +P_{(0,1)}row¹+P_{(0,0)}, where (5)

P_{(n,m)} through P_{(0,0)} are coefficients determined and stored during a calibration process discussed below. The notation “row” refers to a variable which is the row value of the pixel determined with respect to an origin (0,0) located near the center of the array and scaled to a value between −1 and +1, depending on the pixel location in the array relative to the center (0,0). The letter “m” represents the order of the polynomial.

As equations (1) through (5) illustrate, the polynomial approximating the correction factor has n+1 Q coefficients. Each Q coefficient is approximated by a polynomial having m+1 P coefficients. In the above equations, the first coefficients, Qₙ, P_{(n,m)}, P_{(n-1,m)}, . . . , P_{(1,m)}, and P_{(0,m)}, are referred to as leading coefficients.

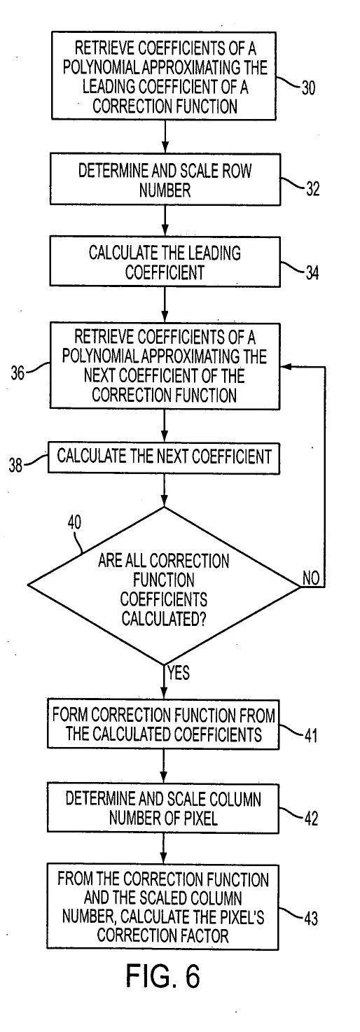

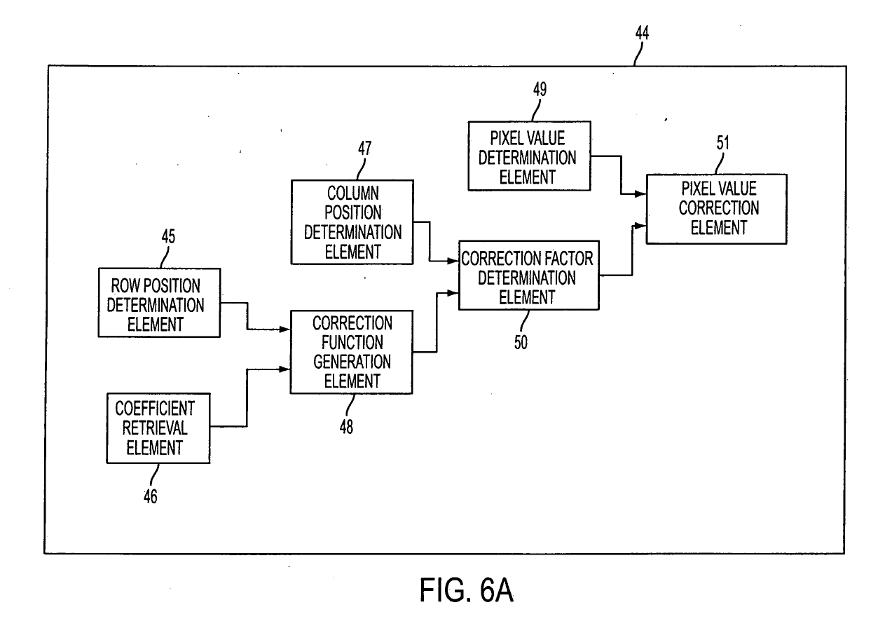

FIG. 6 illustrates a method for calculating a correction factor for a pixel in a row of pixels as implemented by image processor 10 utilizing this polynomial approach. First, at step 30, image processor 10 retrieves from a memory the P coefficients of the polynomial approximating the leading coefficient (Qₙ) of the correction function, which correspond to coefficients P_{(n,m)}, P_{(n, m-1)}, . . . , P_{(n, 1)}, P_{(n, 0)} in equation (2). Next, the image processor 10 acquires the row number and scales the row number to a value between −1 and +1 (step 32). Next, image processor 10 determines the value of leading coefficient Qₙ by evaluating the polynomial formed from the scaled row number and these P coefficients (step 34). At steps 36, 38 and 40, image processor 10 repeats the processes of retrieving P coefficients for the next Q coefficient of the correction function and evaluating the polynomial formed from the retrieved P coefficients and the scaled row value. For example, image processor 10 would next calculate Qₙ₋₁ by retrieving coefficients P_{(n-1, m)}, P_{(n-1, m-1)}, . . . , P_{(n-1, 1)}, P_{(n-1, 0)}, inputting the scaled row number, and evaluating the polynomial. Once the image processor 10 has calculated all the Q coefficients of the correction function (Qₙ, Qₙ₋₁, . . . , Q₁, Q₀), image processor 10 can then generate the correction function for the row based on these calculated Q coefficients (step 41).

After image processor 10 has determined the correction function for the row, it can then determine the correction factor for the pixel in the row. To do this, image processor 10 first determines the column number of the pixel in the row and scales the column number to a value between −1 and +1 (step 42) depending on the pixel location in the array relative to the center (0,0). Next, image processor 10 inputs the scaled column number into the correction function and evaluates the correction function (step 43) to determine the correction factor for the pixel.

FIG. 6a illustrates an embodiment of a correction device 44. Correction device 44 includes elements 45-51. Element 45 determines and scales a row number of the array. Element 46 retrieves stored coefficients from a memory. Element 48 generates a correction function for the row based on the scaled row position and the retrieved coefficients. Element 47 determines and scales a column position for a pixel in the row. Element 50 determines a correction factor for the pixel based on the pixel's scaled column position and the correction function generated by element 48. Element 49 determines a pixel value associated with the pixel, and element 51 determines and outputs a correct pixel value by multiplying the pixel value determined by element 49 by the correction factor determined by element 50. It should be appreciated that the elements 45-51 could be individual circuits or logic, one circuit, a combination of circuits or logic, etc.

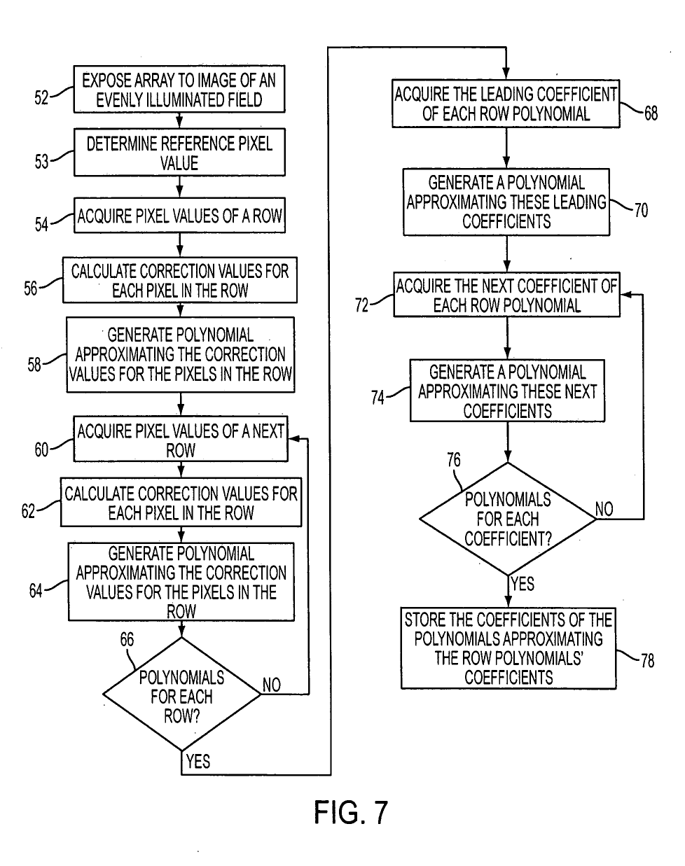

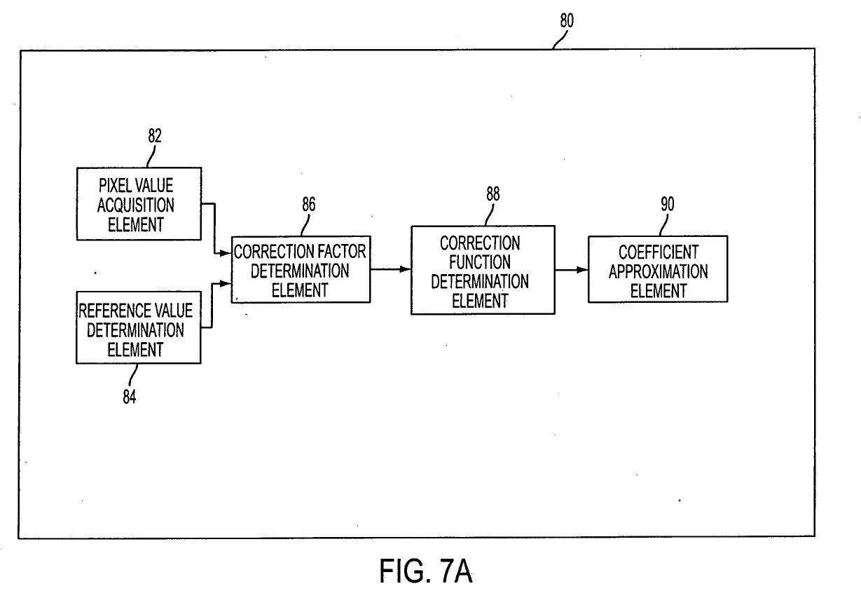

The embodiment shown in FIG. 6 requires a number of P coefficients stored in a memory that is equal to (n+1)×(m+1). FIG. 7 illustrates a method of determining these P coefficients. One could implement the method of FIG. 7 using any type of processing system capable of acquiring and evaluating pixel values from a pixel array. This application refers to such a processing system as a “calibration processor”. The calibration processor could be implemented using image processor 10, using a separate data processing system, or using any other implementation of a data processing system.

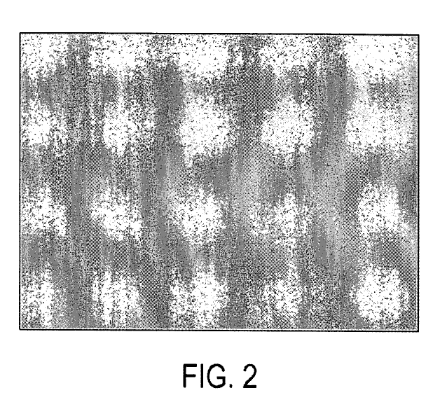

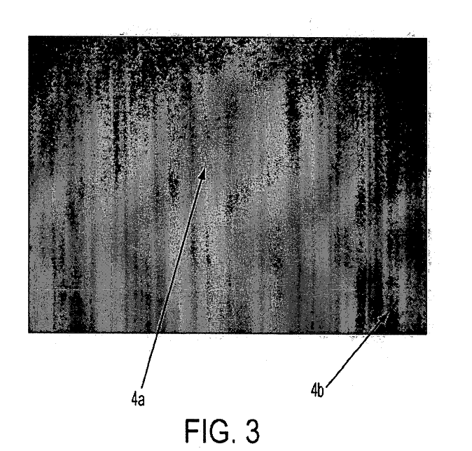

First, at step 52, a pixel array 2 is exposed to an evenly illuminated calibration image field. The calibration image should have characteristics that would cause every pixel in an ideal camera's pixel array to generate the same pixel value. For example, such a calibration image could be an evenly illuminated uniform field like the gray field of FIG. 2.

As explained above, in a typical camera, capturing such a calibration image causes the pixels to generate pixel values that differ from each other and from what is expected. During a calibration phase, the calibration processor designates one of these pixel values as a reference value. The calibration processor then determines correction factors for each of the other pixels based on this reference value. These correction factors are proportioned to the reciprocal of the attenuation of the pixels; in other words, the amount that each pixel value must be multiplied by so that the pixel value equals the reference value.

For example, for 10-bit digital pixel values, each pixel generates a signal representing a number between 1 and 1024. One could generate a calibration field that when photographed by a camera causes a reference pixel to generate a pixel value equal to 512, the pixel's 50% saturation point. If exposing the camera to the same field causes a different pixel to output a pixel value equal to, for example, 450, then the calibration processor would correct that pixel value by multiplying it by

$$\frac{512}{450} ,$$

which corresponds to that pixel value's correction factor.

Steps 53, 54, and 56 of FIG. 7 illustrate a process of calculating correction factors for pixels in an array. After the pixel array is operated to capture a calibration image, the calibration processor selects a reference pixel value from all the pixel values generated by the array (step 53). Next, the calibration processor selects a row in the array and acquires the pixel values generated by each pixel in the row (step 54). Next, for each pixel in the row, the calibration processor determines each pixel's correction factor by dividing the reference pixel value by the pixel's pixel value (step 56).

After the calibration processor calculates correction factors for every pixel in the row, the system calculates a polynomial function approximating the row of correction factors (step 58). Procedures for finding the best-fitting curve to a given set of points are well known and include, but are not limited to, least squares fitting. As illustrated above in equation (1), the letter Q refers to the coefficients of this polynomial. At steps 60 through 66 the calibration processor repeats for each row of the array the process of acquiring the pixel values in the row (step 60), calculating correction factors for each pixel (step 62), and generating a polynomial function approximating the correction factors of the row (step 64).

When the processor completes these steps, it will have generated one polynomial for every row of the pixel array. For example, if the pixel array has 1024 rows, then the calibration processor generates 1024 polynomial functions. If each polynomial is of order five, then each polynomial will have six Q coefficients as in the example equation 1(a) above. In practice, lower order polynomial functions, for example, of order three may be used.

Each of the polynomials generated for each row will have a leading coefficient. At steps 68 and 70, the processor generates a polynomial that approximates these leading coefficients. This is done by fitting the leading coefficients to a curve using any procedure for finding the best-fitting curve to a given set of points, such as, for example, least squares fitting. The polynomial generated corresponds to equation (2) described above.

After generating a polynomial approximating the leading coefficient as a function, the calibration processor then repeats this process to generate polynomials approximating the other coefficients of the row polynomials (steps 72, 74, and 76). These polynomials would correspond to equations (3) through (5) set forth above.

For example, if order three polynomials were chosen to approximate the correction factors for each row, then each polynomial generated for each row would have four coefficients. In this case, the calibration processor would generate four more polynomials: a first polynomial approximating the leading coefficient, a second polynomial approximating the second coefficient, and two other polynomials approximating the third and fourth coefficients. This application uses the letter P to represent the coefficients of these polynomials, as illustrated above in equations (2) to (5). After the processor generates these polynomials approximating the coefficients of all the correction factor polynomials, the processor then stores the P coefficients in a memory (step 78) for use in subsequent pixel value correction procedures, such as the one illustrated in FIG. 6.

FIG. 7a illustrates a calibration device 80 that includes device elements 82, 84, 86, 88, and 90. Element 82 acquires pixel values from a pixel array. Element 84 determines a reference pixel value. Element 86 determines correction factors for each pixel in the array based on pixels values acquired by element 82 and the reference pixel value determined by element 84. Element 88 determines for each row of the array a correction function approximating the correction factors for the pixels in the row. Element 90 determines a polynomial approximating the leading coefficients of each correction function as well as polynomials approximating the other coefficients of each correction function. Element 90 could also store the coefficients of the polynomials it determines. It should be appreciated that the elements 82, 84, 86, 88, and 90 could be individual circuits or logic, one circuit, a combination of circuits or logic, etc

Instead of generating and storing a single set of P coefficients, embodiments could generate and store multiple sets of P coefficients. Each set of P coefficients could be specific to a certain type of pixel, for example, a pixel of a particular color. Having multiple sets of P coefficients where each set regenerates correction functions customized to certain types of pixels can provide better pixel value correction. This could help to correct anomalies related to differences in color type or other anomalies related to differences in pixel position.

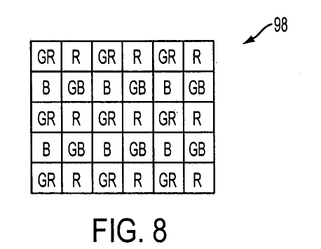

For example, to capture color images, digital cameras often use color filters with a pixel array. This causes certain pixels to only receive certain colors of light. One popular type of filtering arrangement is known as a Bayer color filter array. FIG. 8 illustrates a pixel array utilizing a Bayer color filter array 98. The pixels labeled R represent pixels receiving red light, and the pixels labeled B represent pixels receiving blue light. The pixels labeled GR represent pixels receiving green light which are located in a row with pixels receiving red light, and pixels labeled GB represent pixels receiving green light which are located in a row with pixels receiving blue light. Designers often distinguish between these two types of green pixels because, for various reasons, they can behave differently.

During the calibration process, instead of calculating a single correction function approximating correction factors for every pixel in a row, the calibration processor could calculate two correction functions for the row. A first correction function could approximate the correction factors for one type of color pixel in the row; a second correction function could approximate the correction factors for a second color type of pixel in the row. For example, systems having Bayer color filters have four unique types of pixels. As such, the calibration processor could calculate four unique correction functions for every two rows, thus generating four sets of correction functions. From each of these four sets of correction functions, the calibration processor could then calculate and store four separate sets of P coefficients. During subsequent correction procedures, image processor 10 would be able to regenerate four different calibration functions for every two rows instead of one calibration function for every row.

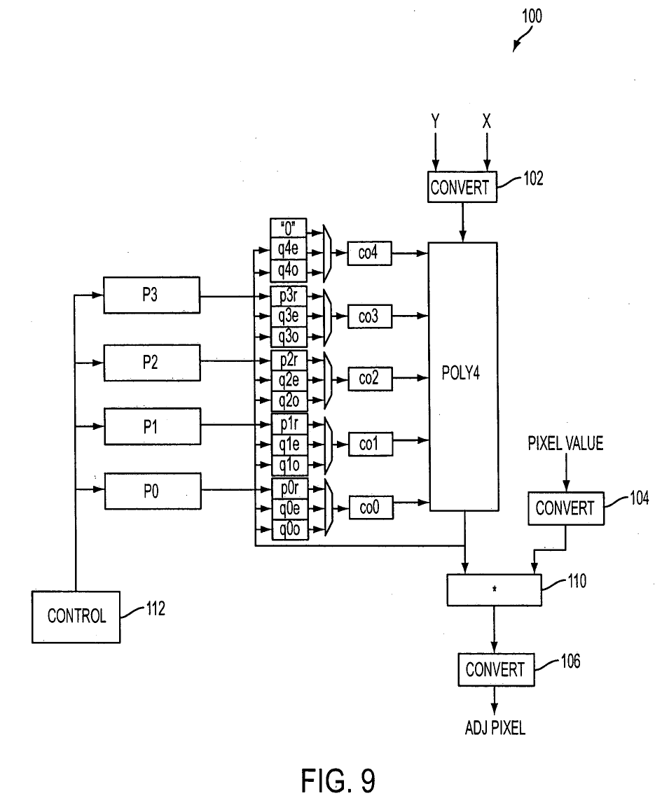

FIG. 9 shows a block diagram of an embodiment of an image processor 10 as a hardware processor 100 which may be used to implement the FIG. 6 correction process. Processor 100 utilizes correction functions of order three. Thus, it will regenerate correction functions having four coefficients. Each coefficient of the correction function is approximated by a polynomial of order four, which has five P coefficients.

Processor 100 operates with a pixel array using a Bayer color filter. As such, this embodiment uses four different sets of P coefficients to regenerate four different correction functions. Each one of these four correction functions corrects one of the four color types of pixels. For example, one set of P coefficients regenerates a correction function approximating correction factors for blue pixels; another set of P coefficients regenerates a correction function approximating correction factors for green pixels located in a row with blue pixels; another set of P coefficients regenerate a correction function approximating a correction factor for red pixels; another set of P coefficients regenerate a correction function approximating correction factors for green pixels located in a row with red pixels.

Each of the four sets of P coefficients contains four subsets of coefficients dedicated to approximating one of the four Q coefficients. For example, the set of P coefficients used to regenerate correction functions for the blue pixels has a subset of coefficients for regenerating the leading Q coefficient of the correction function, a subset of coefficients for regenerating the second Q coefficient of the correction function, and so on. In FIG. 9, components P0, P1, P2, and P3 are register file RAMs for storing these subsets. Register file RAM P3 stores the subset of each of the four sets of P coefficients that generates the leading coefficient of the four correction functions, register file RAM P2 stores the subset of each set of P coefficients that generates the second coefficient of the four correction functions, and so on.

Parts p3r, p2r, p1r, and p0r are registers that temporarily hold coefficients from RAMs P3 through P0. Register “0” represents a register that would be used with an additional register file RAM if one were to approximate each Q coefficient using a polynomial of order 5 instead of order four. Parts q4e, q4o, q3e, q3o, q2e, q2o, q1e, q1o, q0e, and q0o are registers that temporarily store Q coefficients calculated using the P coefficients.

Convert element 102 receives integer values of column and row numbers, converts them to floating point values, and scales them to values between −1 and +1 depending on location of a pixel in an array. Convert element 104 receives integer values of pixel values and converts them to floating point values. Poly4 evaluates a polynomial according to inputted coefficients co4, co3, co2, co1, and co0 and an inputted variable value from convert element 102. Element 110, labeled with an asterisk, performs multiplication; and element 112, labeled Control, provides various control signals. Convert element 106 converts floating point values to integer values. Methods of implementing these elements are well known, and one could implement any of these elements using all hardware, all software, or a combination of software and hardware.

The following describes a way of operating processor 100 to process pixel values in a row having red pixels in even numbered columns and green pixels in odd numbered columns. First, after processing a previous row of pixel values and before reading pixel values in a next row, the system 100 reads from registers P0, P1, P2, and P3 the P coefficients of the polynomial approximating the leading coefficient of the correction function for either the pixels in the even numbered columns of the next row or the pixels in the odd numbered columns of the next row. Next, system 100 receives value Y, which is the integer of the next row of a pixel array. Element 102 scales value Y to a value between −1 and +1, which corresponds to “row” variable of the equations described above. Based on the scaled Y value and the read P coefficients, poly4 calculates the value of the leading coefficient Qn of the correction function. The processor 100 then stores the leading coefficient in either register q4e or q4o depending on whether the leading coefficient corrects pixels in the even numbered columns or pixels in the odd number columns. Next, the processor 100 repeats this process of retrieving stored P coefficients and calculating Q coefficients until all of registers q4e through q0o contain their corresponding Q coefficients. At this point processor 100 will have calculated coefficients for a correction function associated with pixels in the even numbered columns and a correction function associated with pixels in the odd numbered columns.

Once registers q4e through q0o contain their appropriate coefficients, the processor 100 begins reading and processing the pixel values generated by the pixels in the next row. For each pixel in the next row, processor 100 first determines its column value (X), converts the column value to a floating point value, then scales it to a value between −1 and +1. This scaled column value corresponds to the “col” variable of the equations describe above. For even values of X, poly4 calculates a correction factor from the scaled value of X and from coefficients q4e, q3e, q2e, q1e, and q0e. Then the processor 100 multiplies this correction factor by the pixel value acquired from the pixel array to generate a corrected pixel value. In the illustrated embodiment, the pixel value is converted from an integer value to a floating point value by component 104 before the multiplication at component 106.

The embodiment of FIG. 9 uses order four correction functions to approximate the correction factor and order three polynomials to approximate the correction function coefficients. However, one could implement embodiments using functions of any order.

FIG. 9 also illustrates P values stored as floating point values. In the illustrated embodiment, the processor 100 acquires pixel values and their corresponding row and column values as integer values then converts them to floating point values. The processor 100 performs the various calculations on the floating point representations of these values then converts the results from a floating point value to an integer by convert element 106. Although this example illustrates a floating point implementation, one could implement embodiments using various representations, such as the fixed point number representation.

In some embodiments, processor 10 could calculate the Q coefficients during a blanking period that corresponds to a period after reading and processing a previous row of pixels and before reading a next row of pixels. However, other embodiments could perform the various calculations at other points.

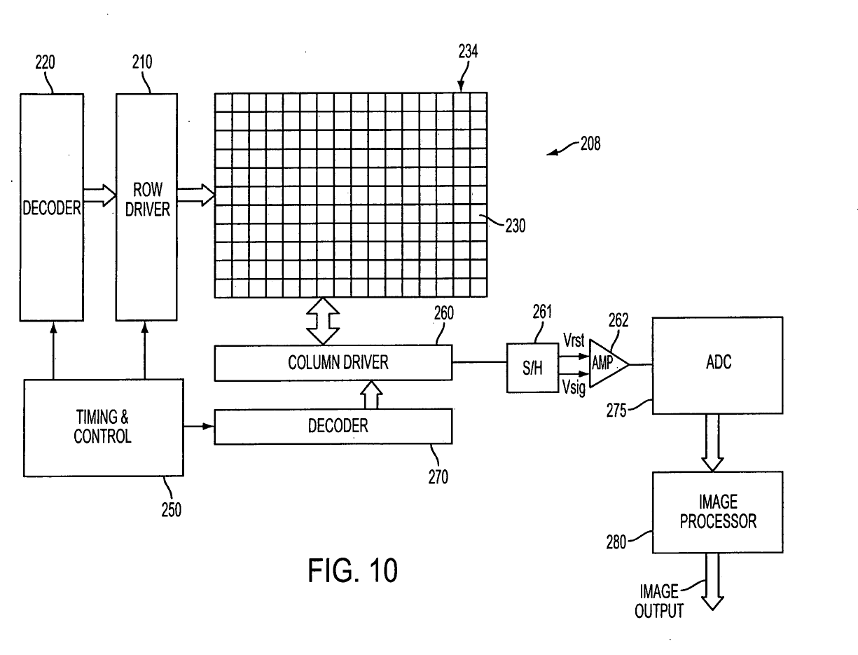

FIG. 10 illustrates an embodiment of an imaging device 208 which can implement the embodiments described above with respect to FIGS. 6 and 9 and which could be implemented on a single semiconductor chip. Imaging device 208 incorporates a CMOS pixel array 234. In operation of imaging device 208, pixels 230 of each row in array 234 are all turned on at the same time by a row select line, and cells 230 of each column are selectively output by respective column select lines. A plurality of row and column lines are provided for the entire array. The row lines are selectively activated in sequence by row driver 210 in response to row address decoder 220 and the column select lines are selectively activated for each row activation by the column driver 260 in response to column address decoder 270. Imaging device 208 is operated by the control circuit 250, which controls address decoders 220, 270 for selecting the appropriate row and column lines for pixel readout, and row and column driver circuitry 210, 260, which apply driving voltage to the drive transistors of the selected row and column lines.

The pixel output signals typically include a reset signal Vᵣₛₜ taken off of a floating diffusion region (via a source follower transistor) when it is reset and a pixel image signal V_{sig}, which is taken off the floating diffusion region (via the source follower transistor) after charges generated by an image are transferred to it. The Vᵣₛₜ and V_{sig} signals for each pixel are read by a sample and hold circuit 261 and are subtracted by a differential amplifier 262, which produces a difference signal (Vᵣₛₜ−V_{sig}) for each pixel 230, which represents the amount of light impinging on the pixel 230. This signal difference is digitized by an analog-to-digital converter (ADC) 275. The digitized cell signals are then fed to an image processor 280 to form a digital image output. Image processor 280 could be implemented using various combinations of processing capabilities. Additionally, image processor 280 could perform the polynomial generation and correction functions described above with respect to FIGS. 6 and 9.

Although FIG. 10 illustrates an imaging device 208 employing a CMOS pixel array, embodiments may also use other image pixel arrays and associated architecture.

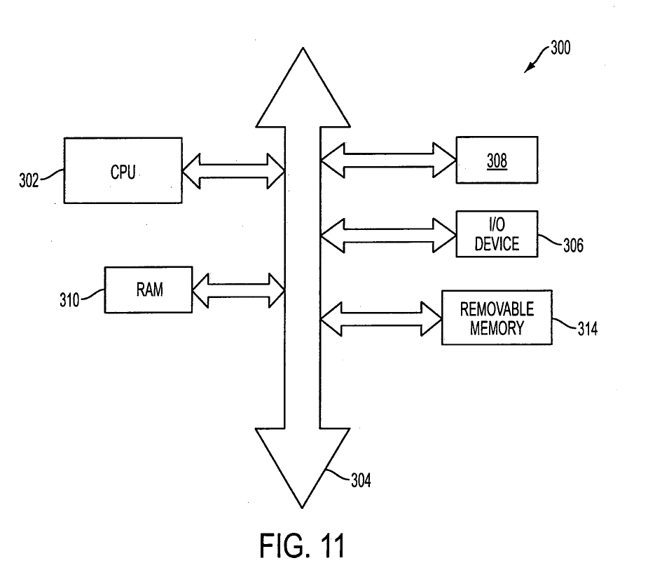

FIG. 11 shows a processor system one could use with an imager device 208. Processor system 300 is an embodiment of a system having digital circuits that could include various components. Without being limiting, such a system could include a computer system, camera system, scanner, machine vision, vehicle navigation, video phone, surveillance system, auto focus system, star tracker system, motion detection system, image stabilization system, and other systems dealing with image files.

System 300, for example a camera system, generally comprises a central processing unit (CPU) 302, such as a microprocessor for controlling camera operations, that communicates with one or more input/output (I/O) devices 306 over a bus 304. The imager device 208 can communicate with CPU 302 over bus 304. Processing system 300 may also include random access memory (RAM) 310, and removable memory 314, such as flash memory, which also communicates with CPU 302 over bus 304.

As mentioned above, embodiments may include various types of imaging devices, for example, charge coupled devices (CCD) and complementary metal oxide semiconductor (CMOS) devices, as well as others.

The above description and drawings illustrate various embodiments. Although certain embodiments have been described above, those skilled in the art will recognize that substitutions, additions, deletions, modifications and/or other changes may be made. Accordingly, the invention is not limited by the foregoing description of example embodiments.

What is claimed as new and desired to be protected by Letters Patent of the United States is:

1. An imager comprising:
an array of pixels producing pixel output signals; and
an image processor configured to receive the pixel output signals and correct the pixel output signals using polynomial based correction factors in accordance with the positions of the pixels within the array.

2. The imager of claim 1, wherein for each pixel of the array, the image processor is further configured to:
retrieve stored values representing polynomials corresponding to the position of the pixel in the array;
generate polynomials using the retrieved values, each of the polynomials defining a portion of a correction factor; and
correct a received pixel signal using the correction factor.

3. The imager of claim 2, wherein:
the following polynomial defines the correction factor,
Qₙcolⁿ+Qₙ₋₁colⁿ⁻¹+ . . . +Q₁col¹+Q₀;
the following polynomials define coefficients Qₙ through Q₀,
Qₙ=P_{(n,m)}row^{m}+P_{(n,m-1)}row^{m-1}+ . . . +P_{(n,1)}row¹+P_{(n,0)},
Qₙ₋₁=P_{(n-1,m)}row^{m}+P_{(n-1,m-1)}row^{m-1}+ . . . +P_{(n-1,1)}row¹+P_{(n-1,0)},
. . .
Q₁=P_{(1,m)}row^{m}+P_{(1,m-1)}row^{m-1}+ . . . +P_{(1,1)}row¹+P_{(1,0)},
Q₀=P_{(0,m)}row^{m}+P_{(0,m-1)}row^{m-1}+ . . . +P_{(0,1)}row¹+P_{(0,0)}; and
values P_{(n,m)} through P_{(0,0)} correspond to the stored values,
where the variable col represents and has a value depending on the location of a pixel in a column of the array, and
where the variable row represents and has a value depending on the location of a pixel in a row of the array.

4. The imager of claim 3, wherein:
the variable col has a value between −1 and +1 depending on a location relative to a reference location in the array.

5. The imager of claim 3, wherein:
the variable row has a value between −1 and +1 depending on a location relative to a reference location in the array.

6. The imager of claim 1, wherein:
the positions of the pixels within the array correspond to row and column values; and
the image processor scales the row and column values to between −1 and +1.

7. The imager of claim 1, wherein:
the image processor corrects the pixel output signals through execution of software instructions stored on a computer readable storage medium.

8. An image processor comprising
circuitry adapted to:
determine a correction factor for a pixel value received from a pixel in a pixel array according to a first polynomial function and the location of the pixel in the array; and
modify the pixel value based on the correction factor.

9. The image processor of claim 8, wherein:
the first polynomial function includes a leading coefficient determined according to a second polynomial function and the row location of the pixel.

10. The image processor of claim 9, wherein:
the first polynomial function includes a next coefficient determined according to a third polynomial function and the row location of the pixel.

11. The image processor of claim 9, further comprising:
memory for storing coefficients of the second polynomial function.

12. The image processor of claim 8, wherein:
the location of the pixel includes a column value and a row value for the pixel; and
the circuitry is further adapted to scale the column and row values to a value between +1 and −1, depending on the location in the array.

13. The image processor of claim 8, wherein:
the pixel is a first pixel in a row with a second pixel; and
the circuitry is further adapted to determine a second correction factor for a second pixel value received from the second pixel according to a second polynomial function and the location of the second pixel.

14. A camera system comprising:
a pixel array; and
a processor adapted to adjust a pixel value from a pixel in a pixel array by a correction amount determined from the location of the pixel in the array and a polynomial function.

15. The camera system of claim 14, wherein the processor is further adapted to:
determine a leading coefficient of the polynomial function according to a row value associated with the pixel and according to a second polynomial function.

16. The camera system of claim 15, further comprising:
memory for storing the coefficients of the second polynomial function.

17. The camera system of claim 14, wherein the processor is further adapted to:
scale row and column values corresponding to the location of the pixel in the array to a value between +1 and −1.

18. The camera system of claim 14, wherein:
the pixel is a first pixel in a row with a least a second pixel; and
the processor is further adapted to adjust a pixel value from the second pixel by a second correction amount determined from the location of the second pixel and a second polynomial function.

19. A computer readable medium comprising image processing software instructions adapted to cause an image processing system to implement a method comprising:
adjusting a pixel value from a pixel in a pixel array by a correction amount determined from the location of the pixel in the array and a polynomial function.

20. The computer readable medium of claim 19, wherein the method further comprises:
determining a leading coefficient of the polynomial function according to a row value associated with the pixel and a second polynomial function.

21. The computer readable medium of claim 19, wherein the method further comprises:
scaling row and column values corresponding to the location of the pixel in the array to a value between +1 and −1.

22. The computer readable medium of claim 19, wherein:
the pixel is a first pixel; and
the method further comprises adjusting a second pixel value from a second pixel located in the same row as the first pixel by a second correction amount determined from the location of the second pixel and a second polynomial function.

23. A method of processing image signals from a pixel array, the method comprising:
determining a leading coefficient of an adjustment polynomial based on a row value for a pixel of the array and coefficients of a first polynomial;
determining a next coefficient of the adjustment polynomial based on the row value and coefficients of a second polynomial;
determining a column value associated for the pixel;
determining an adjustment amount based at least on the leading coefficient of the adjustment polynomial, the next coefficient of the adjustment polynomial, and the column value; and
multiplying a pixel value of the pixel by the adjustment amount.

24. The method of claim 23, further comprising:
determining the leading and next coefficients of the adjustment polynomial before determining the column value.

25. The method of claim 23, further comprising:
converting the pixel value to a floating point value before multiplying the pixel value by the adjustment amount.

26. A calibration processor comprising:
circuitry adapted to:
receive signals from pixels in a row of a pixel array produced in response to capturing a reference image;
determine correction factors for each received signal;
determine a polynomial that approximates the correction factors; and
store values which can be used to regenerate the polynomial.

27. The calibration processor of claim 26, wherein the circuitry is further adapted to:
determine the polynomial using least squares fitting.

28. The calibration processor of claim 26, wherein the circuitry is further adapted to:
determine the correction factors based on a signal from a reference pixel.

29. The calibration processor of claim 28, wherein:
the correction factors are values that the signals are multiplied by so that the signal corresponds to a signal from the reference pixel.

30. The calibration processor of claim 26, wherein the circuitry is further adapted to:
receive signals from pixels in a plurality of rows of the pixel array; and
determine for each row a polynomial that approximates the correction factors associated with the pixels in the row.

31. The calibration processor of claim 30, wherein the circuitry is further adapted to:
determine a leading coefficient polynomial that approximates the leading coefficients of each polynomial; and
store in a memory the coefficients of the leading coefficient polynomial.

32. The calibration processor of claim 31, wherein the circuitry is further adapted to:
determine the leading coefficient polynomial using least squares fitting.

33. An imager comprising:
a processor adapted to:
determine correction values for pixels in a pixel array based on deviations of pixel values from a reference pixel value; and
determine a polynomial approximating the correction values for the pixels.

34. The imager of claim 33, wherein the processor is further adapted to:
determine for each of a plurality of rows a polynomial approximating the correction values associated with the row.

35. The imager of claim 34, wherein the processor is further adapted to:
determine a polynomial approximating the leading coefficients of the polynomials determined for each row of the array.

36. The imager of claim 33, wherein the processor is further adapted to:
determine the polynomial using least squares fitting.

37. A computer readable medium comprising image processing software instructions adapted to cause an image processing system to implement a method comprising:
receiving signals from pixels in a row of a pixel array;
determining correction factors for each received signal; and
determining a polynomial that approximates the correction factors.

38. The computer readable medium of claim 37, wherein the method further comprises:
determining the polynomial using least squares fitting.

39. The computer readable medium of claim 37, wherein the method further comprises:
determining the correction factors based on a signal from a reference pixel.

40. The computer readable medium of claim 39, wherein the method further comprises:
the correction factors are values that the signals are multiplied by so that the signal correspond to a signal from the reference pixel.

41. The computer readable medium of claim 37, wherein the method further comprises:
receiving signals from pixels in a plurality of rows of the pixel array; and
determining for each row a polynomial that approximates the correction factors associated with the pixels in the row.

42. The computer readable medium of claim 41, wherein the method further comprises:
determining a leading coefficient polynomial that approximates the leading coefficients of each polynomial; and
storing the coefficients of the leading coefficient polynomial.

43. The computer readable medium of claim 42, wherein the method further comprises:
determining the leading coefficient polynomial using least squares fitting.

44. A method of providing calibration information for a pixel array, the method comprising:
exposing a pixel array to a reference image;
acquiring first pixel values from pixels in a first row of a pixel array;
determining first adjustment values based on the first pixel values;
determining a first polynomial approximating the first adjustment values;
acquiring second pixel values from pixels in a second row of the array;
determining second adjustment values based on the second pixel values;
determining a second polynomial approximating the second adjustment values;
determining a third polynomial approximating the leading coefficients of the first and second polynomials; and
storing the coefficients of the third polynomial in a memory.

45. The method of claim 44, further comprising:
acquiring fourth pixel values from second pixels in the first row of the array;
determining fourth adjustment values based on the fourth pixel values;
determining a fourth polynomial approximating the fourth adjustment values;
acquiring fifth pixel values from second pixels in the second row of the array;
determining fifth adjustment values based on the fifth pixel values;
determining a fifth polynomial approximating the fifth adjustment values;
determining a sixth polynomial approximating the leading coefficients of the fourth and fifth polynomials; and
storing the coefficients of the sixth polynomial in a memory.

46. The method of claim 44, further comprising:
designating a pixel in the pixel array a reference pixel.

47. The method of claim 46, further comprising:
determining the first adjustment values based on a pixel value acquired from the reference pixel.

48. The method of claim 44, further comprising:
determining any of the first, second, or third polynomials using least squares regression.

49. The method of claim 44, wherein:
the pixel values result from the array being exposed to a calibration image.
